(19) United States
(12) Patent Application Publication
(10) Pub. No.: US 2014/0376207 A1
(43) Pub. Date: Dec. 25, 2014

(54) OPTICAL APPARATUS FOR ILLUMINATING A PIXEL MATRIX AND/OR A CONTROLLABLE SPATIAL LIGHT MODULATOR FOR A DISPLAY

(71) Applicant: SEEREAL TECHNOLOGIES S.A., Munsbach (LU)

(72) Inventor: Gerald Futterer, Dresden (DE)

(21) Appl. No.: 14/371,769

(22) PCT Filed: Jan. 11, 2013
(86) PCT No.: PCT/EP2013/050528

§ 371 Date: Jul. 11, 2014

(30) Foreign Application Priority Data
Jan. 11, 2012 (DE) 10 2012 100 211.8

(51) Int. Cl. F21V 8/00; G03H 1/04; G02B 27/22

(52) U.S. Cl. CPC G02B 6/0035; G02B 27/22; G03H 1/0408; G02B 5/32
USPC 362/97.1; 359/15; 359/3

(57) ABSTRACT

The invention relates to optical device for illuminating a pixel matrix and/or a controllable spatial light modulator for a display, in particular a stereoscopic or holographic 3D display, wherein the optical device comprises a layer formed as a light waveguide, in which illumination light is guided in a light guiding layer, in particular according to the principle of total internal reflection, between two reflection layers lying opposite one another, wherein an extraction means for extracting illumination light from the light guiding layer is provided. The optical device is characterized in that the extraction means has different properties, in particular different optical properties, at a first extraction position than at another extraction position different to the first extraction position.

The invention relates to an optical device for illuminating a pixel matrix and/or a controllable spatial light modulator for a display, in particular a stereoscopic or holographic 3D display, wherein the optical device comprises a layer formed as a light waveguide, in which illumination light is guided in a light guiding layer, in particular according to the principle of total internal reflection, between two reflection layers lying opposite one another, wherein an extraction means for extracting illumination light from the light guiding layer is provided.

The invention also relates to an illumination device and a display having such an optical device.

The invention furthermore relates to a method for producing an optical device for illuminating a pixel matrix and/or a controllable spatial light modulator for a display, in particular a stereoscopic and/or holographic 3D display, in particular for producing an optical device of the aforementioned type, wherein an extraction means for extracting illumination light from a light waveguide, which comprises a light guiding layer in which illumination light can be guided, in particular according to the principle of total internal reflection, between two reflection layers lying opposite one another, is produced from a holographic recording material by exposure of the holographic recording material.

Displays with flat, planar light guides for the backlighting of a pixel matrix or of a controllable spatial light modulator are known in various embodiments. The use of a planar light guide for backlighting has the particular advantage in that it can be made flat. The light input into the planar light guide is reflected at the interfaces of the light guide by total internal reflection, and can thus propagate in the light guide. In order to extract respectively a part of the light propagating in the light guide in the direction of a pixel matrix, for example an LCD matrix, defects or an extraction grating may for example be provided at one of the interfaces.

WO 2004/109380 A1 discloses a scanning backlighting device for a flat display. In this device, the light of matricially arranged LEDs (Light Emitting Diodes) is reflected by means of a cylindrical mirror into the thick end of an essentially flat wedge-shaped light guide. Of the light propagating in the light waveguide, a part is respectively extracted with the aid of a prism sheet in order to illuminate an LCD element.

A device of the type mentioned in the introduction, in which a holographic extraction grating is provided, is known for example from the scientific publication “Short period holographic structures for backlight display applications”, Roberto Caputo et al., OPTICS EXPRESS 10540, Vol. 15, No. 17.

It is an object of the present invention to provide an optical device for illuminating a pixel matrix and/or a controllable spatial light modulator for a display, which can be adapted very flexibly and individually to specific illumination requirements.

The object is achieved by an optical device of the type mentioned in the introduction, which is characterized in that the extraction means has different properties, in particular different optical properties, at a first extraction position than at another extraction position different to the first extraction position.

It is a further object of the present invention to provide a method which makes it possible to produce an optical device, adapted flexibly and individually to specific illumination requirements, for illuminating a pixel matrix and/or a controllable spatial light modulator for a display.

The further object is achieved by a method which is characterized in that exposure which differs from the exposure at a second position, different to the first position, is carried out at a first position of the recording material, or in that the holographic recording material differs at a second position different to a first position.

The invention has the advantage that, in particular, very homogeneous flat illumination can be achieved. This is, in particular, because specific position-dependent properties of the components of an illumination device or of a display, which comprises an optical device according to the invention, can be compensated for by a special position-dependent design of the optical properties of the extraction means. In this regard, for example, the extraction means may be provided to a certain extent with properties complementary to other components of an illumination device or of a display, in order to achieve a particular illumination requirement, for example illumination which is particularly homogeneous in respect of the intensity distribution and/or for example illumination with illumination light with a particular angular divergence.

According to a particular embodiment, the reflection layers have a non-zero angle between them, and/or the light guiding layer is wedge-shaped. In particular, an angle between the reflection layers may be between one fifth of a degree and one twentieth of a degree, in particular one tenth of a degree, and/or a wedge angle of the light guiding layer may be between one fifth of a degree and one twentieth of a degree, in particular one tenth of a degree. A wedge-shaped design can achieve the effect that the angle of incidence of the light propagating inside the light guiding layer when it arrives at the reflection layers increases with an increasing number of reflections. In such a configuration, in particular, it may be advantageous for different optical properties to be imparted to different extraction positions of the extraction means, in such a way that each extraction position only extracts illumination light with a particular angle of incidence or illumination light from a particular angle of incidence range, and does not extract the rest of the illumination light.

As an alternative, the reflection layers may be arranged mutually parallel. In particular, the light guiding layer may be formed as a plane-parallel plate.

According to a particular embodiment, the illumination light input into the light guiding layer propagates in a zigzag shape between the reflection layers. Such an embodiment may, in particular, be formed so that input illumination light is reflected to and fro in a zigzag shape between the reflection layers, in such a way that it propagates away from an input position and the not yet extracted components successively reach different extraction positions at which there are different properties of the extraction means, in particular different optical properties of the extraction means. In this way, for example, it is possible to establish that illumination light which has already travelled a longer distance in the light guiding layer is, for example, extracted at a different extraction angle and/or with a different extraction efficiency and/or with a different extraction divergence, than illumination light which has already been extracted after a short distance in the light guiding layer.

In particular, at least one of the reflection layers may reflect the illumination light according to the principle of total reflection, or both reflection layers may reflect the illumination light according to the principle of total reflection. As an alternative, at least one of the reflection layers may also be formed by a mirror or by a reflection grating, in particular a holographic reflection grating.

A configuration in which the extraction means is arranged on one of the reflection layers, in particular surface-wide, is particularly efficient and robust.

The extraction means may for example be formed as a grating, in particular as a holographic volume grating. The extraction means may, in particular, be formed as a holographic transmission grating or as a holographic reflection grating.

As already mentioned, the extraction means may for example respectively have a different diffraction efficiency at different positions.

In particular, the extraction means, which may for example be formed as a holographic grating, may ensure that each time the light propagating inside the light guiding layer arrives, a light component for the backlighting for example of a pixel matrix or an LCD is extracted. The extraction means is, for example, not formed spatially constantly in this case, but rather in such a way that, for example, the extraction factor η increases in a direction away from an input position in order to achieve an essentially uniform light intensity of the extracted light spatially over the entire surface of the light guide.

In particular, in order to achieve illumination which is homogeneous over the entire surface in respect of the light power, the diffraction efficiency of the extraction means may increase in one direction, particularly in a direction in which the thickness of the light guiding layer decreases.

In a particular configuration, the extraction means has a different thickness at different positions. In particular, the thickness of the extraction means may increase in a selected direction, particularly in a direction in which the thickness of the light guiding layer decreases. Such an embodiment has the particular advantage that a constant divergence of the extracted illumination light can be achieved over the entire extraction surface, irrespective of the position of the extraction.

The fact that the thickness, for example of a transmission grating, is an essential parameter for the divergence of the transmitted light is used in this case. The same also applies similarly for a reflection grating, the thickness of the reflection grating being an essential parameter for the divergence of the reflected light. Such an embodiment may, in particular, compensate for the fact that an inadvertent angle error during the input of the illumination light into the light guiding layer, particularly in the case of a wedge-shaped light guide, increases with an increasing number of the (zigzag) reflections on the reflection surfaces.

In a very particular embodiment, the extraction means, particularly in the form of a holographic grating, is formed in order to extract illumination light arriving from the light guiding layer only when it has a particular angle of incidence or when the angle of incidence lies within a particular angle of incidence range. In particular, the extraction means may extract illumination light arriving from the light guiding layer only when it has an angle of incidence of from 40 degrees to 50 degrees, in particular from 43 degrees to 47 degrees, in particular from 44 degrees to 46 degrees, in particular 45 degrees, or when it has an angle of incidence of 50 degrees (i.e. 50°).

According to a very particularly advantageous embodiment, the extraction means, particularly in the form of a holographic grating, extracts illumination light at a first extraction position only when it has a particular angle of incidence or when the angle of incidence lies within a particular first angle of incidence range, and the extraction means, particularly in the form of a holographic grating, extracts illumination light at a second extraction position, different to the first extraction position, only when it has a particular second angle of incidence, different to the first angle of incidence, or when the angle of incidence lies within a particular second angle of incidence range different to the first angle of incidence range.

Such an embodiment has the very particular advantage that different extraction positions are respectively characterized by a special angle of incidence required for the extraction or by a special necessary angle of incidence range required for the extraction. Such an embodiment therefore offers the possibility, by controlled influencing for example of the light power of different components of the illumination light with different propagation directions, and therefore with different angles of incidence at which the different components of the illumination light arrive on the extraction means, to exert a controlled influence on the extraction position at which light is extracted (for example in relation to the wavelength) or the light power with which illumination light is extracted.

For example, the angle of incidence at which the extraction means extracts illumination light from the light waveguide may increase in the direction away from an input position of the light waveguide. Depending on the application, as an alternative the angle of incidence at which the extraction means extracts illumination light from the light waveguide may decrease in the direction away from an input position of the light waveguide.

In order to implement this principle, an illumination device, in particular a backlighting device for a display, having an optical device according to the invention, may comprise a light source, the illumination light of which passes through a control plane as divergent light, each position of the control plane being assigned an extraction position of the extraction element, in such a way that the angles of incidence required to bring about extraction are different at different extraction positions of the extraction element.

For example with a control means arranged in the control plane, at least one illumination light component with a particular propagation direction can be stopped down or attenuated. Since, as explained, each propagation direction is necessarily assigned the respective angle of incidence, at which the illumination light component arrives on the extraction means, by the respectively given geometry of the optical structure, each illumination light component is therefore also necessarily assigned at least one extraction position. By controlled influencing of the intensity or the divergence or other properties of the illumination light component, it is possible to establish accurately how and to what extent the illumination light component is extracted at the assigned extraction position. In particular, the extraction at the positions where excessively much illumination light emerges from the light guiding layer can in this way be attenuated in a controlled way in order, for example, to achieve homogeneous illumination over the entire surface.

In a simple embodiment, the control means is formed as an aperture with adjustable opening width. It is, however, also possible for the control means itself to be formed as a controllable pixel matrix. Such an embodiment allows particularly accurate control of the light distribution of the extracted illumination light as a function of the extraction position.

In a particular embodiment, the extraction means is formed in such a way that it extracts illumination light at an emergence angle in the range of from −3 to +3 degrees, in particular at an emergence angle of 0 degrees.

For example in order to impart additional beam guiding functions to the extraction means, in addition to its extraction function, according to a particular embodiment the extraction means extracts illumination light at different emergence angles at different positions. For example, a field lens effect (additional to the extraction function) may advantageously be achieved in that the extraction means extracts illumination light in such a way that the propagation directions of the illumination light extracted at different positions intersect at a point, along a line or in a spatially limited small region, or in a focal region.

Extraction means having one or more of the properties described above may be produced particularly accurately in that the extraction means is produced by in-situ exposure of a holographic recording material as a hologram. In particular, the extraction means may be constructed in a plurality of layers, at least one layer being produced by in-situ exposure, i.e. in particular by exposure at the position of subsequent use relative to other components.

An embodiment in which the extraction means is produced by exposure of a layer of holographic recording material applied onto the light waveguide is particularly robust and reliable.

Particularly in order to impart particular additional properties to the extraction means, and/or in order to impart particular position-dependent properties, in particular optical properties, to the extraction means, the extraction means may advantageously be produced by exposure of a layer of holographic recording material, at least a part of the exposure light reaching the layer of holographic recording material through the light waveguide during the exposure. In this regard, it has been discovered that particularly elaborate extraction means, which are complicated in terms of the position-dependent properties, cannot be produced, or can be produced only with difficulty, by only exposing the holographic material from the outside—i.e. not through the light guiding layer.

For example, as already mentioned, in displays which are intended for generating a holographic 3D image, it is advantageous for the extracted illumination light, with which a pixel matrix or a controllable spatial light modulator is illuminated, to have spherical wavefronts, even though the preferably coherent light input into the relevant light guide has planar wavefronts. In this way, imaging of the light source into a user plane is de facto achieved, the radius of curvature of the wavefronts corresponding to the observer distance. Such embodiments can, as described, be produced particularly accurately and reliably. In this case, it has been discovered in particular that the specific particular properties can be imparted with particularly easy and high quality to the hologram to be produced when the light path along which the illumination light subsequently travels is at least partially used for the exposure. In this case, the exposure light may propagate in the same direction as the illumination light does subsequently. It may however—depending on the application—, as explained in detail below, also be advantageous for the exposure light to follow the opposite direction to the subsequent illumination light path. Generation of the image of the light source in a user plane is expedient in particular in a holographic display, such as is described for example in WO 2006/066919 A1 or in WO 2006/119760 A2 or in another publication in the name of the Applicant. To this extent, the present invention is preferably used for such a holographic display. Accordingly, the disclosure content of WO 2006/066919 A1 and/or WO 2006/119760 A2 is fully incorporated here.

Owing to the fact that the exposure light is not only directed onto the holographic recording material from the free half-space, but can also arrive on the recording material from the side on which the light waveguide lies, during the exposure it is possible to produce interference patterns which cannot be generated with production methods known from the prior art.

In a particular embodiment, the thickness of the extraction means is selected in such a way that the angular divergence of the extracted illumination light is less than 2 degrees, in particular less than 0.5 degree, in particular less than 1/20 degree, in particular less than 1/60 degree, or lies in the range of from 1/20 degree to 1/60 degree.

Limiting the divergence to the range of the maximum possible angular resolution of the human eye, which is about 1/60 degree, has the very particular advantage that, for example in holographic applications, a pixel matrix or a controllable spatial light modulator can be illuminated in such a way that blurred representations of image information do not occur because of superpositions, visible to the human eye, of coherent illumination light. For the case in which coherent illumination takes place only in one spatial direction, the divergence in this spatial direction should lie at least in the range of from 1/20 degree to 1/60 degree, and should in particular be less than 1/60 degree, while restriction of the angular divergence to less than 2 degrees is sufficient in the incoherent spatial direction. Particularly in the case of most extraction means produced as a hologram, these constraints may be achieved for example by the extraction means having a thickness of from 400 micrometers to 600 micrometers, in particular 500 micrometers, at least at one position.

Preferably, the extraction direction is different at different extraction positions of the extraction means, but the thickness of the extraction means is selected in such a way that the angular divergence of the illumination light extracted at one extraction position, in particular an extraction position for illuminating a single pixel of a pixel matrix or a single pixel of a controllable spatial light modulator, is less than 0.5 degree, in particular less than 1/20 degree, in particular less than 1/60 degree, or lies in the range of from 1/20 degree to 1/60 degree.

According to a particular embodiment, the angular divergence of the extracted illumination light satisfies the aforementioned conditions even when the extraction direction is different at different extraction positions of the extraction means.

Particularly in order to produce homogeneous illumination or in order to produce illumination in which there are no abrupt changes in respect of the light power and/or the extraction angle and/or the angular divergence between individual regions of the illumination surface, the optical properties of the extraction means may vary continuously and/or constantly from the first extraction position to the second extraction position separated from the first extraction position. Such an embodiment may, for example, be produced by the optical conditions of the exposure of a holographic recording material varying continuously and/or constantly as a function of the exposure position. In particular, the optical conditions of the exposure of a holographic recording material may advantageously not vary abruptly as a function of the exposure position.

As already mentioned, an optical device according to the invention as claimed in one of claims 1 to 14 may advantageously be incorporated in an illumination device, in particular a backlighting device, for a display, in particular for a stereoscopic or holographic 3D display, or in a display, in particular a 3D display, in particular a stereoscopic or holographic 3D display.

Preferably, the illumination device comprises a light source, the illumination light of which passes through a control plane as divergent light, each position of the control plane being assigned an extraction position of the extraction element, in such a way that the angles of incidence required to bring about extraction are different at different extraction positions of the extraction element.

A control means, in particular an adjustable aperture, for controlled stopping down or attenuation of at least one illumination light component with a particular propagation direction, may be provided in the control plane.

More particularly preferably, a display or 3D display, in particular a stereoscopic or holographic 3D display, comprises an optical device as claimed in one of claims 1 to 14 and/or an illumination device as claimed in one of claims 15 to 17.

As likewise already mentioned, in order to produce the optical device according to the invention, the exposure at the first position may differ from the exposure at the second position by a different exposure intensity and/or by a different exposure dose and/or by a different exposure angle. As an alternative or in addition, the holographic recording material at the first position may differ from the recording material at the second position by a thickness and/or by a spectral sensitivity and/or by its chemical composition.

As already mentioned, in respect of the position-dependent differences of the optical properties, particularly elaborate extraction means can be produced particularly accurately and reliably as a hologram in that at least a part of the light path—optionally in the opposite propagation direction—as is also provided for the subsequent illumination light is used for the exposure.

In particular, at least a part of the exposure light may be directed through the light waveguide to the holographic recording material during the exposure, and/or the holographic recording material may be applied—in particular surface-wide—on a reflection layer, at least a part of the exposure light being directed through the other reflection layer to the holographic recording material during the exposure.

As an alternative or in addition, the light waveguide may have an input position for input of the exposure light, and at least a part of the exposure light may be directed through the input position to the holographic recording material during the exposure, and/or the holographic recording material may be applied on a reflection layer and first exposure light, in particular of a first exposure light source, may be directed through the other reflection layer to the holographic recording material during the exposure, and second exposure light, in particular of a second exposure light source, may simultaneously be directed through an input position of the light waveguide for the illumination light to the holographic recording material during the exposure.

For example so that different extraction positions only extract illumination light with a respectively different angle of incidence or respectively different angle of incidence range from the light guiding layer, at least a part of the exposure light may advantageously have a curved, in particular cylindrical or spherical, wavefront in the region in which it acts on the holographic recording material. In this way, for example, different grating directions can be produced at different extraction positions. It is also alternatively or additionally possible in this way to assign different diffraction angles to different extraction positions.

In particular, the exposure may be carried out sequentially in a plurality of exposure steps, or the exposure may be carried out sequentially in a plurality of exposure steps, the position and/or orientation of the light waveguide together with the holographic recording material being modified between the exposure steps. As an alternative, the exposure may also be carried out sequentially in a plurality of exposure steps, the position and/or orientation of the light waveguide together with the holographic recording material being modified between the exposure steps, while the position and/or orientation of at least one exposure light source, preferably of all exposure light sources, and/or the exposure beam path remains unchanged. It is also possible for the exposure to be carried out sequentially in a plurality of exposure steps, the light waveguide together with the holographic recording material being rotated about two mutually perpendicular axes between two exposure steps.

The subject-matter of the invention is represented schematically in the drawing and will be described below with the aid of the figures, elements which are the same or have the same effect mostly being provided with the same references.

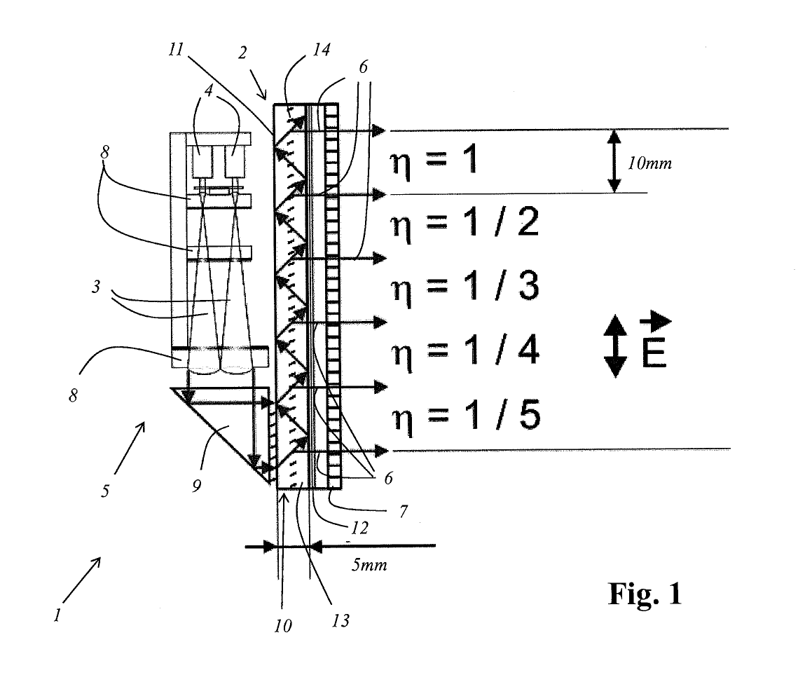

FIG. 1 shows an exemplary embodiment of an illumination device comprising a device according to the invention for a display, and

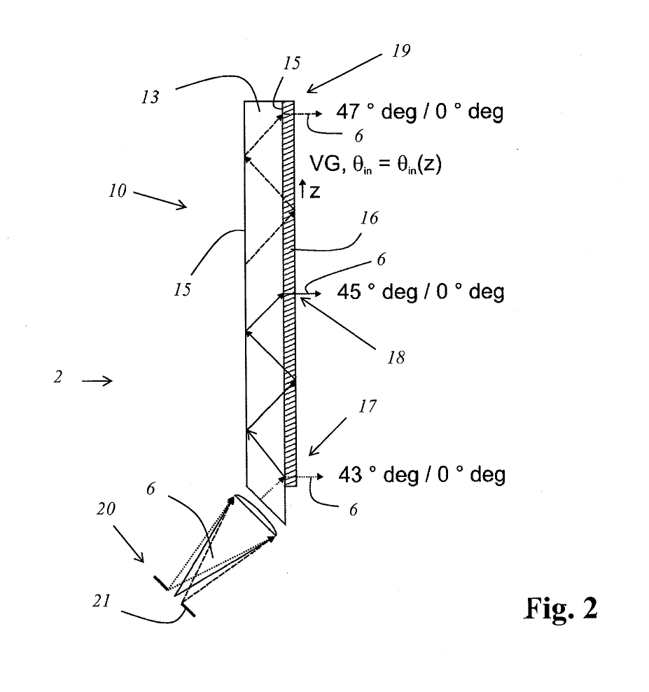

FIG. 2 shows an exemplary embodiment of an optical device according to the invention.

FIG. 1 shows an exemplary embodiment of an illumination device for a display 1, comprising an optical device 2 according to the invention, into which light 3 of a plurality of light sources 4 is input by an input device 5, and from which light is extracted as illumination light 6 and directed onto a controllable spatial light modulator 7.

The light 3 of the plurality of light sources 4 is collimated with the aid of light shaping elements 8, such as apertures and lenses, and deviated by means of a deviating prism 9 to the optical device 2 for directing illumination light 6 onto the controllable spatial light modulator 7. The optical device 2 comprises a light guiding layer 13 formed as a planar light waveguide 10, in which illumination light 6 is guided between two mutually opposite extensive reflection means, namely a first reflection means 11 and a second reflection means 12.

The first reflection means 11 of the light waveguide 10 reflects light contained in the light guiding layer 13 according to the principle of total internal reflection, while the second reflection means 12, namely the reflection means 12 facing toward the controllable spatial light modulator 7 to be illuminated, is formed as a dielectric RGB mirror—i.e. as a mirror for the primary colors—and fully reflects light incident at an angle of incidence of 45 degrees.

In order to extract the illumination light 6 from the light guiding layer 13, an extraction means, namely a holographic volume grating 14, is provided, this being indicated only schematically.

The holographic volume grating 14 ensures that each time the input light 3 propagating inside the light guide 10 arrives, a light component for the backlighting of a controllable spatial light modulator 7 is extracted. The holographic volume grating 14 is formed not spatially constantly, but in such a way that the extraction factor η increases in a direction away from the input device 5 in order to achieve an essentially uniform light intensity of the extracted light 13 spatially over the entire surface of the light guide.

Expressed concisely, a flat illumination unit is represented, which, by means of a volume grating 14, extracts light 3 in the form of plane wave segments in the direction of a controllable spatial light modulator 7 (SLM), a dielectric mirror being used on the side of the device 2 facing away from the input device 5 in order to ensure almost complete reflection at 45 degrees for light of the colors used. The mirror may be a vapor-deposited dielectric layer stack. As an alternative, a reflection volume grating may be used.

FIG. 2 shows an exemplary embodiment of an optical device 2 according to the invention, having a light waveguide 10 which comprises a light guiding layer 13, inside which input illumination light 6 propagates in a zigzag shape between two reflection surfaces 15. An extraction means 16, which is formed as a holographic grating, is applied fully on one of the reflection surfaces 15.

The extraction means 16 extracts illumination light 6 at a first extraction position 17 only when it has a particular angle of incidence, namely an angle of incidence of 43 degrees. At a second extraction position 18, the extraction means 16 extracts illumination light 6 only when it has a particular second angle of incidence, different to the first angle of incidence, namely an angle of incidence of 45 degrees. At a third extraction position 19, the extraction means 16 extracts illumination light 6 only when it arrives on the extraction means 16 at an angle of incidence of 47 degrees. At all extraction positions 17, 18, 19, however, the extracted part of the illumination light 6 is respectively deviated in such a way that it emerges from the extraction means 16 at an emergence angle of 0 degrees.

In this way, different extraction positions 17, 18, 19 are respectively characterized by a particular angle of incidence required for the extraction, so that by controlled influencing of the light power of different components of the illumination light with a different propagation direction, which finally arrive on the extraction means 16 at different angles of incidence, influence can for example be exerted in a controlled way as to the light power with which illumination light 6 is respectively extracted from which extraction position 17, 18, 19.

To this end, a control means 21, which is formed as an aperture whose transmission width is adjustable and with which, in a controlled manner, at least one illumination light component of the divergent illumination light 6 coming with a particular propagation direction from a light source (not represented in detail) can be stopped down or attenuated, is arranged in a control plane 20. Since, as explained, each propagation direction is necessarily assigned to the respective angle of incidence at which the illumination light component arrives on the extraction means 16, by the given geometry of the optical structure, each illumination light component is therefore necessarily also assigned at least one extraction position 17, 18, 19. By controlled influencing of the intensity, it is possible to establish accurately how and to what extent the illumination light component is extracted at the assigned extraction position.

For example, precisely that light component of the divergent illumination light 6 passing through the control plane 20, which arrives at the first extraction position 17 precisely with the required angle of incidence of 43 degrees, may be cut by means of the aperture formed as a control means 21 and thereby attenuated. The effect achieved by this is that less illumination light 6 is extracted from the light guiding layer 13 in the region of the first extraction position 17 relative to the other extraction positions 18, 19, when this is for example necessary in order to match the illumination light intensities present at the various extraction positions 17, 18, 19 to one another. It is also possible in this way, for example with a rapidly switchable control means 21, to temporarily darken regions of the illumination device in a controlled way, when this is advantageous for example in order to represent particular image information, for example for an image representation with high contrast. In this way, for example, it is possible to produce an illumination device with which a so-called scanning backlight is possible. For example, an angle-modifying active optical component, in particular a scan mirror or an LC grating with actively driven electrodes—particularly as described in WO 2010/149587 A2, the disclosure content of which is fully incorporated here—may be used. With such an active optical component, there are scarcely any light losses, or low light losses, since the light is in this case deviated and the light is not stopped down or absorbed—as in other alternatives using shutters or adjustable apertures.

The invention has been explained with reference to a particular embodiment. It is, however, clear that variants or modifications may be made without thereby departing from the protective scope of the following claims.

1. An optical device for illuminating a pixel matrix and/or a controllable spatial light modulator for a display, in particular a stereoscopic or holographic 3D display, wherein the optical device comprises a layer formed as a light waveguide, in which illumination light is guided in a light guiding layer, in particular according to the principle of total internal reflection, between two reflection layers lying opposite one another, wherein an extraction means for extracting illumination light from the light guiding layer is provided, wherein the extraction means has different properties, in particular different optical properties, at a first extraction position than at another extraction position different to the first extraction position.

2. The optical device as claimed in claim 1, wherein
a. the reflection layers have a non-zero angle between them, and/or the light guiding layer is wedge-shaped, and/or an angle between the reflection layers is between one fifth of a degree and one twentieth of a degree, in particular one tenth of a degree, and/or a wedge angle of the light guiding layer is between one fifth of a degree and one twentieth of a degree, in particular one tenth of a degree, or in that
b. the reflection layers are arranged mutually parallel or the light guiding layer is formed as a plane-parallel plate, and/or
c. the illumination light input into the light guiding layer propagates in a zigzag shape between the reflection layers.

3. The optical device as claimed in claim 1, wherein at least one of the reflection layers reflects the illumination light according to the principle of total reflection, or in that both reflection layers reflect the illumination light according to the principle of total reflection.

4. The optical device as claimed in claim 1, wherein the extraction means is arranged on one of the reflection layers, in particular surface-wide.

5. The optical device as claimed in claim 1, wherein
a. the extraction means is formed as a grating, in particular as a holographic volume grating, or
b. the extraction means is formed as a holographic transmission grating, or
c. the extraction means is formed as a holographic reflection grating.

6. The optical device as claimed in claim 1, wherein the extraction means has a different diffraction efficiency at different positions, and/or the diffraction efficiency of the extraction means increases in one direction, particularly in a direction in which the thickness of the light guiding layer decreases.

7. The optical device as claimed in claim 1, wherein the extraction means has a different thickness at different positions, and/or the thickness of the extraction means increases in one direction, particularly in a direction in which the thickness of the light guiding layer decreases.

8. The optical device as claimed in claim 1, wherein
a. the extraction means, particularly in the form of a holographic grating, is formed in order to extract illumination light arriving from the light guiding layer only when it has a particular angle of incidence or when the angle of incidence lies within a particular angle of incidence range, and/or
b. the extraction means, particularly in the form of a holographic grating, is formed in order to extract illumination light arriving from the light guiding layer only when it has an angle of incidence of from 40 degrees to 50 degrees, in particular from 43 degrees to 47 degrees, in particular from 44 degrees to 46 degrees, in particular 45 degrees, or when it has an angle of incidence of 50 degrees.

9. The optical device as claimed in claim 1, wherein the extraction means, particularly in the form of a holographic grating, extracts illumination light at a first extraction position only when it has a particular angle of incidence or when the angle of incidence lies within a particular first angle of incidence range, and the extraction means, particularly in the form of a holographic grating, extracts illumination light at a second extraction position, different to the first extraction position, only when it has a particular second angle of incidence, different to the first angle of incidence, or when the angle of incidence lies within a particular second angle of incidence range different to the first angle of incidence range.

10. The optical device as claimed in claim 9, wherein
a. the angle of incidence at which the extraction means extracts illumination light from the light waveguide increases in the direction away from an input position of the light waveguide, or
b. the angle of incidence at which the extraction means extracts illumination light from the light waveguide decreases in the direction away from an input position of the light waveguide.

11. The optical device as claimed in claim 1, wherein
a. the extraction means extracts illumination light at an emergence angle in the range of from −3 to +3 degrees, in particular at an emergence angle of 0 degrees, and/or
b. the extraction means extracts illumination light at different emergence angles at different positions, or
c. the extraction means extracts illumination light in such a way that the propagation directions of the illumination light extracted at different positions intersect at a point, along a line or in a focal region.

12. The optical device as claimed in claim 1, wherein
a. the extraction means is produced by in-situ exposure of a layer of holographic recording material, and/or in that
b. the extraction means is produced by exposure of a layer of holographic recording material applied onto the light waveguide, and/or
c. the extraction means is produced by exposure of a layer of holographic recording material, at least a part of the exposure light reaching the layer of holographic recording material through the light waveguide during the exposure.

13. The optical device as claimed in claim 1, wherein
a. the extraction means has a thickness of from 400 micrometers to 600 micrometers, in particular 500 micrometers, at least at one position, and/or
b. the thickness of the extraction means is selected in such a way that the angular divergence of the extracted illumination light is less than 2 degrees, in particular less than 0.5 degree, in particular less than 1/20 degree, in particular less than 1/60 degree, or lies in the range of from 1/20 degree to 1/60 degree, and/or
c. the extraction direction is different at different extraction positions of the extraction means, but in that the thickness of the extraction means is selected in such a way that the angular divergence of the illumination light extracted at one extraction position, in particular an extraction position for illuminating a single pixel of a pixel matrix or a single pixel of a controllable spatial light modulator, is less than 0.5 degree, in particular less than 1/20 degree, in particular less than 1/60 degree, or lies in the range of from 1/20 degree to 1/60 degree.

14. The optical device as claimed in claim 1, wherein the optical properties of the extraction means vary continuously and/or constantly from the first extraction position to the second extraction position separated from the first extraction position.

15. An illumination device, in particular a backlighting device, for a display, in particular for a stereoscopic or holographic 3D display, comprising an optical device for illuminating a pixel matrix and/or a controllable spatial light modulator for the display, wherein the optical device comprises a layer formed as a light waveguide, in which illumination light is guided in a light guiding layer, in particular according to the principle of total internal reflection, between two reflection layers lying opposite one another, wherein an extraction means for extracting illumination light from the light guiding layer is provided, wherein the extraction means has different properties, in particular different optical properties, at a first extraction position than at another extraction position different to the first extraction position.

16. The illumination device as claimed in claim 15, wherein a light source is provided, the illumination light of which passes through a control plane as divergent light, each position of the control plane being assigned an extraction position of the extraction element, in such a way that the angles of incidence required to bring about extraction are different at different extraction positions of the extraction element.

17. The illumination device as claimed in claim 16, wherein a control means, in particular an adjustable aperture, for controlled stopping down or attenuation of at least one illumination light component with a particular propagation direction is provided in the control plane.

18. A 3D display, comprising an optical device for illuminating a pixel matrix and/or a controllable spatial light modulator for the display, wherein the optical device comprises a layer formed as a light waveguide, in which illumination light is guided in a light guiding layer, in particular according to the principle of total internal reflection, between two reflection layers lying opposite one another, wherein an extraction means for extracting illumination light from the light guiding layer is provided, wherein the extraction means has different properties, in particular different optical properties, at a first extraction position than at another extraction position different to the first extraction position.

19. A method for producing an optical device for illuminating a pixel matrix and/or a controllable spatial light modulator for a display, in particular a stereoscopic or holographic 3D display, in particular for producing an optical device as claimed in claim 1, wherein an extraction means for extracting illumination light from a light waveguide, which comprises a light guiding layer in which illumination light can be guided, in particular according to the principle of total internal reflection, between two reflection layers lying opposite one another, is produced from a holographic recording material by exposure of the holographic recording material, wherein exposure which differs from the exposure at a second position, different to the first position, is carried out at a first position of the recording material, or in that the holographic recording material differs at a second position different to a first position.

20. The method as claimed in claim 19, wherein the exposure at the first position differs from the exposure at the second position by a different exposure intensity and/or by a different exposure dose and/or by a different exposure angle.

21. The method as claimed in claim 19, wherein the holographic recording material at the first position differs from the recording material at the second position by a thickness and/or by a spectral sensitivity and/or by its chemical composition.

22. The method as claimed in claim 19, wherein the holographic recording material is applied on a reflection layer, and/or the holographic recording material is applied surface-wide on a reflection layer.

23. The method as claimed in claim 19, wherein
a. at least a part of the exposure light is directed through the light waveguide to the holographic recording material during the exposure, and/or
b. the holographic recording material is applied on a reflection layer, and at least a part of the exposure light is directed through the other reflection layer to the holographic recording material during the exposure, and/or
c. the light waveguide has an input position for input of the exposure light, and in that at least a part of the exposure light is directed through the input position to the holographic recording material during the exposure, and/or
d. the holographic recording material is applied on a reflection layer, and first exposure light, in particular of a first exposure light source, is directed through the other reflection layer to the holographic recording material during the exposure, and in that second exposure light, in particular of a second exposure light source, is simultaneously directed through an input position of the light waveguide for the illumination light to the holographic recording material during the exposure.

24. The method as claimed in claim 19, wherein at least a part of the exposure light has a curved, in particular spherical, wavefront in the region in which it acts on the holographic recording material.

25. The method as claimed in claim 19, wherein
a. the exposure is carried out sequentially in a plurality of exposure steps, or
b. the exposure is carried out sequentially in a plurality of exposure steps, the position and/or orientation of the light waveguide together with the holographic recording material being modified between the exposure steps, or
c. the exposure is carried out sequentially in a plurality of exposure steps, the position and/or orientation of the light waveguide together with the holographic recording material being modified between the exposure steps, while the position and/or orientation of at least one exposure light source, preferably of all exposure light sources, and/or the exposure beam path remains unchanged, and/or
d. the exposure is carried out sequentially in a plurality of exposure steps, the light waveguide together with the holographic recording material being rotated about two mutually perpendicular axes between two exposure steps.
